(19) United States
(12) Patent Application Publication
(10) Pub. No.: US 2014/0193724 A1
(43) Pub. Date: Jul. 10, 2014

(54) GRAVITY FEED FLOW BATTERY SYSTEM AND METHOD

(71) Applicant: Ashlawn Energy, LLC, Alexandria, VA (US)

(72) Inventors: Maurice Daniel, Alexandria, VA (US); Michael Cooney, Hot Springs, AR (US); Joseph F. Startari, South Euclid, OH (US)

(73) Assignee: Ashlawn Energy, LLC, Alexandria, VA (US)

(21) Appl. No.: 14/147,515

(22) Filed: Jan. 4, 2014

Related U.S. Application Data
(60) Provisional application No. 61/848,454, filed on Jan. 4, 2013.

(51) Int. Cl. H01M 8/04; H01M 8/18; H01M 8/20

(52) U.S. Cl. CPC H01M 8/04276; H01M 8/20; H01M 8/188
USPC 429/408

(57) ABSTRACT

A gravity feed flow battery system and method are provided. The gravity feed flow battery system includes a first battery stack including a first half-cell utilizing a liquid electrolyte, a first gravity feed system, including at least a first storage tank and a first standpipe, designed to generate a first hydrostatic pressure in the first standpipe for the liquid electrolyte in the first standpipe sufficient to force the liquid electrolyte to be fed from the first gravity feed system through the first half-cell, and a return system to return the liquid electrolyte from the first half-cell to the first gravity feed system. There may be multiple gravity feed systems, including a gravity feed system for a positive electrolyte and a gravity feed system for a negative electrolyte. The gravity feed flow battery system may have a two-tank flow battery configuration, or a four-tank flow battery configuration.

### CROSS-REFERENCE TO RELATED APPLICATIONS

This application claims the benefits of U.S. Provisional Patent Application No. 61/848,454, filed on Jan. 4, 2013, in the U.S. Patent and Trademark Office, the disclosure of which is incorporated herein by reference.

### BACKGROUND

1. Field

One or more embodiments related to a flow battery system having a gravity feed system, and more particularly, to a flow battery system having a gravity feed system that uses a standpipe to generate sufficient head pressure at a battery stack to force electrolyte through the battery stack for charging or discharging the flow battery system.

2. Description of the Related Art

Reduction-oxidation (redox) flow batteries, also known as regenerative fuel cells, or reversible fuel cells, or secondary fuel cells, are a type of storage battery having two liquid electrolytes; a positive electrolyte or catholyte, and a negative electrolyte or anolyte.

The two electrolytes are typically separated from one another by an ion exchange membrane. In this type of battery the two electrodes are typically inert and primarily serve to collect or distribute the electric charge from the battery cell(s). The membrane may divide the battery into two half-cells, for example. Here, each half-cell may generally be made up of a rectangular frame with a central rectangular cavity, with the membrane being stretched across one side of the frame and a conductive graphite plate serving as the electrode and extending across the other side of the frame. In such an arrangement, a rectangle of electrically conductive carbon felt may be cut to fit inside and fill the entire cavity of the half-cell to assist in collecting or distributing electric charge from the electrolyte. Positive electrolyte would fill the positive half-cell and negative electrolyte would fill the negative half-cell within the carbon felt. Both electrolytes are usually metal salts in an acid solution. For example in an iron/chrome couple redox flow battery the negative electrolyte contains iron ions and the positive electrolyte contains chromium ions, both dissolved in a hydrochloric acid solution. In a flow battery the positive and negative electrolyte solutions are stored in tanks external to the battery and pumps are typically used to feed the electrolytes through their respective half-cells during charging and discharging periods of operation.

In a conventional redox battery system the electrolytes may be drawn out of their respective storage tanks by such pumps and injected into the bottom of the battery stack. If the battery stacks are placed above the storage tanks the electrolyte emerging from the top of the battery stack may be allowed to drain by gravity back into the storage tanks; otherwise the electrolyte may be pumped back into the storage tanks.

FIG. 1 illustrates a pump-feed redox flow battery system with a battery stack elevated above storage tanks for gravity return. In this two-tank arrangement, positive electrolyte is stored in one tank and negative electrolyte is stored in the other tank with complete symmetry between the two halves of the system. The electrolyte 115 is drawn out of the bottom of storage tanks 101 by the action of feed pumps 105. One-way valves 106, located just after the feed pumps 105, prevents flow-back of the electrolyte when the pump is turned off. Electrolyte is usually then forced through the bottom of the battery stack 104 and out the top of the battery stack 104. The battery stack 104 is located above the storage tanks 101 to allow for “gravity return” to direct the electrolyte fluid back into the storage tanks 101 using gravity. The electrolyte flows through pipe 107 into the top of the storage tank 101 where it is then sprayed, or dripped, onto the top of the electrolyte contained in the tank. This spraying of electrolyte into the storage tank 101 prevents an electrical circuit from being formed in the fluid loop thus reducing shunt current losses. An inert gas 114, such as nitrogen or argon, may be maintained at the top of the storage tank 101 to prevent oxidation of the reactants. Some sort of snorkel mechanism 108 may be placed at the top of the storage tank 101 to allow equalization of the gas pressure 114 inside the storage tank 101 to the ambient air outside the storage tank 101. This standard arrangement allows for storage tanks 101 to be positioned at ground level and the elevated battery stack allows the processed electrolyte to flow back into the storage tanks 101 through gravity return, e.g., without additional return pumps.

In this arrangement, because the feed pumps 105 feed the respective electrolytes from the storage tanks 101 to the battery stack 104, a flow rate of respective electrolytes through the battery stack 104 is influenced by the feed pumping, and thus, the flow rate through the battery stack 104 would be subjected to fluctuations in pump performance.

A second method of circulating the electrolyte is to place the storage tanks higher than the battery stack and let gravity feed the electrolyte into the battery stack and use pumps to return the electrolytes from the battery stack back to the tanks. This second method, known as “gravity feed”, has been used in the laboratory to demonstrate such a flow battery concept, but these laboratory demonstrated concepts have not previously been reduced to practice in large flow batteries, such systems greater than tens of kilowatts to megawatts of electric energy. For example, in an example vandadium based electrolyte sulfuric acid solution, it may be necessary to elevate over 10 gallons of positive and negative electrolyte solution to store just one kilowatt of electric energy. Thus, in this example, to store just 10 kilowatts of electric energy it is necessary to elevate over 100 gallons of the sulfuric acidic solution at a height above the battery stack.

FIG. 2 illustrates such an experimental gravity feed flow battery with storage tanks elevated above a battery stack for gravity feed. In this arrangement, the storage tanks 201 are elevated and the battery stack 204 is near ground level, thus allowing the electrolytes to flow from the storage tanks 201 to the battery stack 204 by the action of gravity. Electrolytes contained in elevated storage tanks 201 flow out the bottom of the elevated storage tanks 201 through pipes 202 and into the bottom of the battery stack 204 after first passing through variable valves 203. After leaving the top of the battery stack 204 the electrolyte is pulled by return pumps 205 and returned through pipes 207 back to the tops of the elevated storage tanks 201. One-way valves 206 are positioned at appropriate positions along the flow path to prevent back-flow of the electrolyte. The return pipe 207 is terminated by a nozzle, a drip pan, or other elements to return the fluid back into its reservoir in storage tanks 201 such that it does not form an electrical return path that would contribute to the shunt current system losses.

The maximum gravity feed pressure at the bottom of the battery stack 204 of FIG. 2 is determined by the height H. For example, when respective variable valves 203 are open, the respective hydrostatic pressure at an outlet of each of the storage tanks 201 can then be reflected as the gravity feed pressure or head pressure at the inlet of the battery stack 204. However, in this particular arrangement the return pumps 205 may also contribute suction on the electrolyte flow, which would increase the flow rate through the battery stack 204. Thus the flow rate through the battery stack 204 may be determined by the pressure differential between the initial gravity induced head pressure at the bottom of the battery stack 204, or inlet to the battery stack 204, and the pump induced suction at the top of the battery stack 204. It may be ideal that, after passing through the battery stack 204 (or plural battery stacks 204) over a height of h, resistance to the flow causes the fluid pressure to drop to near zero at the top of the battery stack 204 (or at the top of the last battery stack 204 when there are plural in-line battery stacks 204). In such an arrangement, at a minimum the pumps 205 would then pump the respective electrolyte from the top of the battery stack 204 to the top of the storage tanks 201 to overcome a height difference of H-h.

In this arrangement, because pumping is used to return the respective electrolytes to the storage tanks 201 and the flow rate through the battery stack 204 may be influenced by the return pumping, the flow rate through the battery stack 204 would still be subjected to fluctuations in pump performance, thus reducing the advantages of using gravity feed in this arrangement.

FIG. 3 illustrates a gravity feed system having tall electrolyte storage tanks 301, according to one or more embodiments. As illustrated, the electrolytes flow from the storage tanks 301, through pipes 302, and into the bottom of the battery stack 304. The maximum head pressure at the bottom of the battery stack 304, e.g., when the variable valve 303 is fully open, may be determined by the height H, from the bottom of the battery stack 304 to the top of the liquid in the storage tanks 301. An advantage of the tall storage tanks 301 over the elevated storage tanks 201 of FIG. 2 is the reduction of some of the safety hazards of having the entire volume of electrolyte acids stored in a storage tank above the battery stack 304.

In FIG. 3 the electrolyte storage tanks 301 is situated at ground level. The bottoms of the storage tanks 301 are shown to have a funnel like shape that protrudes somewhat into the ground, and some of the plumbing is also shown below ground level.

The gravity feed method of supplying electrolyte to a battery stack has several advantages over the conventional pump-fed method. First of all the gravity feed method can produce a very uniform laminar flow in the battery stack for better battery performance and efficiency. The efficiency is improved as the reduction in turbulence reduces pumping requirements, and thereby cuts the energy cost of operating the battery. A second advantage is in “black start” operations where the system must quickly respond to a power outage where external power is not available to operate the pumps.

The problem for a large battery using gravity feed is that this gravity feed flow battery approach typically requires thousands of gallons of acid in storage tanks to be placed at an elevated height, which would be both expensive and dangerous. These storage tanks may occasionally leak due to a variety of possible causes, including containment failures and natural disasters. Such accidental spills are made worse by above ground placement of the storage tanks, where leaking electrolyte acid could potentially rain down on workers trying to repair the leaking components. These cost and safety factors are one of the primary reasons that gravity feed is not used in large conventional redox flow batteries.

### SUMMARY

One or more embodiments include a flow battery system including a first battery stack including a first half-cell utilizing a liquid electrolyte, a first gravity feed system, including at least a first storage tank and a first standpipe, designed to generate a first hydrostatic pressure in the first standpipe for the liquid electrolyte in the first standpipe sufficient to force the liquid electrolyte to be fed from the first gravity feed system through the first half-cell, and a return system to return the liquid electrolyte from the first half-cell to the first gravity feed system.

The sufficiency of the first hydrostatic pressure in the first standpipe, to force the liquid electrolyte to be fed through the first half-cell, may be based on any inlet suction pressure of the first half-cell produced by the return system. The return system may includes a return pump to pump the liquid electrolyte into the first storage tank after having exited the first half-cell.

The flow battery may further include a controller to control a height of the liquid electrolyte in the first standpipe to match a predetermined height above a height of the first battery stack to generate the sufficient first hydrostatic pressure to force the liquid electrolyte to be fed from the first gravity feed system through the first half-cell when charging or discharging battery cells of the first battery stack. The sufficient first hydrostatic pressure may be a hydrostatic pressure that generates a head pressure at the first battery stack that is greater than a minimum head pressure needed to force the liquid electrolyte to be fed through the first battery stack.

The flow battery may further include a variable valve in a fluid transport path of the liquid electrolyte being fed from the first gravity feed system to the first battery stack, wherein the controller controls a variable opening of the variable valve to control a flow rate of the liquid electrolyte through the first battery stack when charging or discharging through battery cells of the first battery stack.

A lowest level of the battery stack may be higher than a lowest level of the liquid electrolyte in the first storage tank.

The first gravity feed system may feed the liquid electrolyte from the first standpipe or the first storage tank to the first battery stack without using a pump. The flow battery may further include a controller to control a height of the liquid electrolyte in the first standpipe to match a predetermined height to generate the sufficient first hydrostatic pressure in the first standpipe to force the liquid electrolyte to be fed from the first gravity feed system through the first half-cell.

The flow battery may further include a variable valve in a fluid transport path of the liquid electrolyte being fed from the first gravity feed system to the first battery stack, wherein the controller controls a variable opening of the variable valve to control a flow rate of the liquid electrolyte through the first battery stack when charging or discharging through battery cells of the first battery stack.

The return system may be a gravity return system, such that the liquid electrolyte is fed into the first storage tank after having exited the first half-cell without using a pump.

The first gravity feed system may feed the liquid electrolyte from the first storage tank to the first battery stack without using a pump, and the first storage tank may be pressure sealed and in fluid connection with the first standpipe so as to equalize fluid pressures between the first storage tank and the first standpipe and so to produce a head pressure at the first battery stack based on the first hydrostatic pressure in the first standpipe. The first hydrostatic pressure in the first standpipe may be based on a height of the liquid electrolyte in the standpipe from an outlet of the standpipe providing the fluid connection with the first storage tank to a top of the fluid electrolyte in the standpipe. In addition, the return system may further include a return pump to pump liquid electrolyte from the first battery stack to the first standpipe.

The first gravity feed system may further include a standpipe pump to pump liquid electrolyte from the first storage tank to the first standpipe. The flow battery may further include a controller to control a height of the liquid electrolyte in the first standpipe, to match a predetermined height above the first battery stack to generate the sufficient first hydrostatic pressure to force the liquid electrolyte to be fed from the first gravity feed system through the first half-cell, by controlling the standpipe pump to selectively pump the liquid electrolyte from the first storage tank to the first standpipe when the controller determines that the height of the liquid in the liquid electrolyte in the first standpipe is below the predetermined height.

A top of the first standpipe may be fitted with a snorkel that serves to equalize pressures inside a top-most portion of the first standpipe with an atmospheric pressure existing outside the standpipe.

A top portion of the first standpipe may have an expanded bulbous cavity compared to a mid height portion of the first standpipe to buffer changes in fluid height and turbulence created when the fluid electrolyte is fed into the first standpipe.

The first gravity feed system may further include an overflow pipe installed near a top of the first standpipe to direct excess electrolyte from inside the first standpipe into the first storage tank.

The flow battery may further include a second battery stack, including a second half-cell, at a height different from a height of the first battery stack, and the first gravity feed system may further includes a second standpipe, designed to generate a second hydrostatic pressure in the second standpipe for the liquid electrolyte in the second standpipe sufficient to force the liquid electrolyte to be fed from the first gravity feed system through the second half-cell. The first gravity feed system may feed the liquid electrolyte from the first standpipe to the first battery stack without using a pump, and feed the liquid electrolyte from the second standpipe to the second battery stack without using a pump. The flow battery may further include a controller to control a height of the liquid electrolyte in the first standpipe to match a first predetermined height above a height of the first battery stack to generate the sufficient first hydrostatic pressure to force the liquid electrolyte to be fed from the first gravity feed system through the first half-cell when charging or discharging battery cells of the first battery stack, and to control a height of the liquid electrolyte in the second standpipe to match a second predetermined height above a height of the second battery stack to generate the sufficient second hydrostatic pressure to force the liquid electrolyte to be fed from the first gravity feed system through the second half-cell when charging or discharging battery cells of the second battery stack. The flow battery may further include a first variable valve in a fluid transport path of the liquid electrolyte being fed from the first gravity feed system to the first battery stack, a second variable valve in a fluid transport path of the liquid electrolyte being fed from the first gravity feed system to the second battery stack, and the controller may control a respective variable opening of the first and second variable valves to control respective flow rates of the liquid electrolyte through the first battery stack and the second battery stack when respectively charging or discharging.

The return system may be a gravity return system, such that the liquid electrolyte is fed into the first storage tank after having exited the first half-cell without using a pump and such that the liquid electrolyte is fed into the first storage tank after having exited the second half-cell without using a pump.

The first gravity feed system may further include a first standpipe pump to pump liquid electrolyte from the first storage tank to the first standpipe and a second standpipe pump to pump liquid electrolyte from the first storage tank to the second standpipe. The flow battery may further include a controller to control a height of the liquid electrolyte in the first standpipe, to match a first predetermined height above the first battery stack to generate the sufficient first hydrostatic pressure to force the liquid electrolyte to be fed from the first gravity feed system through the first half-cell, by controlling the first standpipe pump to selectively pump the liquid electrolyte from the first storage tank to the first standpipe when the controller determines that the height of the liquid in the liquid electrolyte in the first standpipe is below the first predetermined height, and to control a height of the liquid electrolyte in the second standpipe, to match a second predetermined height above the second battery stack to generate the sufficient second hydrostatic pressure to force the liquid electrolyte to be fed from the first gravity feed system through the second half-cell, by controlling the second standpipe pump to selectively pump the liquid electrolyte from the first storage tank to the second standpipe when the controller determines that the height of the liquid in the liquid electrolyte in the second standpipe is below the second predetermined height.

The flow battery may further include a second gravity feed system including at least a second storage tank and second standpipe, such that the second gravity feed system is designed to generate a second hydrostatic pressure in the second standpipe for the liquid electrolyte in the second standpipe sufficient to force the liquid electrolyte to be fed from the second gravity feed system through the first half-cell. Liquid electrolyte stored by the first storage tank may be charged electrolyte and liquid electrolyte stored by the second storage tank may be depleted electrolyte. The flow battery system may further include a controller to control a height of the charged liquid electrolyte in the first standpipe to match a first predetermined height above a height of the first battery stack to generate the sufficient first hydrostatic pressure to force the liquid electrolyte to be fed from the first gravity feed system through the first half-cell when discharging battery cells of the first battery stack, and to control a height of the depleted liquid electrolyte in the second standpipe to match a second predetermined height above a height of the first battery stack to generate the sufficient second hydrostatic pressure to force the depleted liquid electrolyte to be fed from the second gravity feed system through the first half-cell when charging battery cells of the first battery stack.

The flow battery may further include a charge/discharge selector valve in a fluid transport path of the charged liquid electrolyte being fed from the first gravity feed system to the first battery stack and in a fluid transport path of the depleted liquid electrolyte being fed from the second gravity feed system to the first battery stack, and a variable valve in a transport fluid path of the charged or depleted liquid electrolyte having passed the charge/discharge selector valve to the first battery stack, wherein the controller controls a respective variable opening of the variable valve to control a flow rate of the charged or depleted liquid electrolyte through the first battery stack when respectively charging or discharging, and controls the charge/discharge valve to transport charged liquid electrolyte from the first gravity feed system to the first battery stack when discharging the first battery stack and to transport depleted liquid electrolyte from the second gravity feed system to the first battery stack when charging the first battery stack. The return system may be a gravity return system, such that the charged liquid electrolyte is selected to be fed into the first storage tank after having been charged and then exited the first half-cell without using a pump, and the discharged liquid electrolyte is selected to be fed into the second storage tank after having been discharged and then exited the first half-cell without using a pump.

The first gravity feed system may further include a first standpipe pump to pump charged liquid electrolyte from the first storage tank to the first standpipe and a second standpipe pump to pump depleted liquid electrolyte from the second storage tank to the second standpipe. The flow battery system may further include a controller to control a height of the charged liquid electrolyte in the first standpipe, to match a first predetermined height above the first battery stack to generate the sufficient first hydrostatic pressure to force the charged liquid electrolyte to be fed from the first gravity feed system through the first half-cell, by controlling the first standpipe pump to selectively pump the charged liquid electrolyte from the first storage tank to the first standpipe when the controller determines that the height of the charged liquid electrolyte in the first standpipe is below the first predetermined height, and to control a height of the depleted liquid electrolyte in the second standpipe, to match a second predetermined height above the first battery stack to generate the sufficient second hydrostatic pressure to force the depleted liquid electrolyte to be fed from the second gravity feed system through the first half-cell, by controlling the second standpipe pump to selectively pump the depleted liquid electrolyte from the second storage tank to the second standpipe when the controller determines that the height of the depleted liquid electrolyte in the second standpipe is below the second predetermined height. The first predetermined height may be equal to the second predetermined height.

The sufficiency of the first hydrostatic pressure in the first standpipe, to force the liquid electrolyte to be fed through the first half-cell, may be based on a configuration of the first battery stack having an inlet fed the electrolyte from the first gravity system and/or an outlet to return the electrolyte to the return system be on lateral sides of the first battery stack. The sufficiency of the first hydrostatic pressure in the first standpipe, to force the liquid electrolyte to be fed through the first half-cell, may be based on a configuration of the first battery stack having an inlet fed the electrolyte from the first gravity system and/or an outlet to return the electrolyte to the return system be on top or bottom sides of the first battery stack.

One or more embodiments may include a flow battery system, including a battery stack including a battery cell, half of the battery cell being a half-cell utilizing positive terminal liquid electrolyte and another half of the battery cell being a second half-cell utilizing a negative terminal liquid electrolyte, a first gravity feed system, including at least a first storage tank and a first standpipe for storing the positive terminal liquid electrolyte, designed to generate a first hydrostatic pressure in the first standpipe for the positive terminal liquid electrolyte in the first standpipe sufficient to force the positive terminal liquid electrolyte to be fed from the first gravity feed system through the first half-cell, a second gravity feed system, including at least a second storage tank and a second standpipe for storing the negative terminal liquid electrolyte, designed to generate a second hydrostatic pressure in the second standpipe for the negative terminal liquid electrolyte in the second standpipe sufficient to force the negative terminal liquid electrolyte to be fed from the second gravity feed system through the second half-cell, a first return system to return the positive terminal liquid electrolyte from the first half-cell to the first gravity feed system, and a second return system to return the negative terminal liquid electrolyte from the second half-cell to the first gravity feed system.

The first gravity feed system may feed the positive terminal liquid electrolyte from the first standpipe or the first storage tank to the first half cell without using a pump, and the second gravity feed system may feed the negative terminal liquid electrolyte from the second standpipe or the second storage tank to the second half cell without using a pump.

The flow battery may further include a controller to control a height of the positive terminal liquid electrolyte in the first standpipe to match a first predetermined height to generate the sufficient first hydrostatic pressure in the first standpipe to force the positive terminal liquid electrolyte to be fed from the first gravity feed system through the first half-cell, and to control a height of the negative terminal liquid electrolyte in the second standpipe to match a second predetermined height to generate the sufficient second hydrostatic pressure in the second standpipe to force the negative terminal liquid electrolyte to be fed from the second gravity feed system through the second half-cell. The first predetermined height may be equal to the second predetermined height. The first predetermined height may be different from the second predetermined height, and the controller may control a flow rate of the positive terminal electrolyte through the first half-cell to be different from a controller controlled flow rate of the negative terminal electrolyte through the second half-cell.

The first and second return systems may be gravity return systems, such that the positive terminal liquid electrolyte is fed into the first storage after having exited the first half-cell without using a pump and the negative terminal liquid electrolyte is fed into the second storage after having exited the second half-cell without using a pump.

One or more embodiments include a flow battery control method of a flow battery system including a first battery stack including a first half-cell utilizing a liquid electrolyte, a first gravity feed system including at least a first storage tank and a first standpipe, and a return system to return the liquid electrolyte from the first half-cell to the first gravity feed system, the method including controlling a height of the liquid electrolyte in the first standpipe to match a predetermined height above a height of the battery stack to generate a sufficient first hydrostatic pressure to force the liquid electrolyte to be fed from the first gravity feed system through the first half-cell when charging or discharging battery cells of the first battery stack, and controlling a variable feeding of the liquid electrolyte from the first gravity feed system to the first battery stack, to control a flow rate of the liquid electrolyte through the first battery stack when charging or discharging through battery cells of the first battery stack.

The method may include controlling the return system of the flow battery system to transport the liquid electrolyte, after having exited the first battery stack, to the first storage tank.

The return system may not be a gravity feed return system and may include a return pump, arranged to pump the liquid electrolyte into the first storage tank after having exited the first battery stack, and the method may further include controlling the return pump to transport the liquid electrolyte into the first storage tank after having exited the first battery stack.

The flow battery control method may further include controlling the first gravity feed system to feed the liquid electrolyte from the first standpipe or the first storage tank to the first battery stack without using a pump. The controlling of the variable feeding of the liquid electrolyte may be performed by controlling a variable opening of a variable valve, in a fluid transport path of liquid electrolyte from the first gravity feed system to the first battery stack, and the variable feeding may include controlling a flow rate of the liquid electrolyte in the first battery stack.

The controlling of the height of the liquid electrolyte in the first standpipe may be performed by controlling a standpipe pump, arranged in a fluid transport path between the first storage tank and the first standpipe, to selectively transport fluid electrolyte from the first storage tank to the first standpipe to increase the height of liquid electrolyte in the first standpipe.

The flow battery system may further include a second battery stack, including a second half-cell, at a height different from a height of the first battery stack, and a second standpipe, and the controlling of the height of the liquid electrolyte in the first standpipe may further include controlling a height of the liquid electrolyte in the first standpipe to match a first predetermined height above a height of the first battery stack to generate the sufficient first hydrostatic pressure to force the liquid electrolyte to be fed from the first gravity feed system through the first half-cell when charging or discharging battery cells of the first battery stack, and controlling a height of the liquid electrolyte in the second standpipe to match a second predetermined height above a height of the second battery stack to generate a sufficient second hydrostatic pressure to force the liquid electrolyte to be fed from the first gravity feed system through the second half-cell when charging or discharging battery cells of the second battery stack.

The flow battery system may further include a second gravity feed system, including a second storage tank and second standpipe, liquid electrolyte stored by the first storage tank is charged electrolyte and liquid electrolyte stored by the second storage tank is depleted electrolyte, and the method may further include controlling a height of the charged liquid electrolyte in the first standpipe to match a first predetermined height above a height of the first battery stack to generate the sufficient first hydrostatic pressure to force the charged liquid electrolyte to be fed from the first gravity feed system through the first half-cell when discharging battery cells of the first battery stack, and controlling a height of the depleted liquid electrolyte in the second standpipe to match a second predetermined height above a height of the first battery stack to generate a sufficient second hydrostatic pressure to force the depleted liquid electrolyte to be fed from the second gravity feed system through the first half-cell when charging battery cells of the first battery stack.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of embodiments, taken in conjunction with the accompanying drawings of which:

FIG. 1 illustrates a pump-feed redox flow battery system with a battery stack elevated above storage tanks for gravity return;

FIG. 2 illustrates a gravity feed flow battery with storage tanks elevated above a battery stack for gravity feed;

FIG. 3 illustrates a gravity feed system having tall storage tanks, according to one or more embodiments;

FIG. 4 illustrates a gravity feed system with standpipes and pressurized storage tanks, according to one or more embodiments;

FIG. 5 illustrates a gravity feed and gravity return system with standpipes and an elevated battery stack, according to one or more embodiments;

FIG. 6 illustrates one half-cell side of a four-tank gravity feed and gravity return system with standpipes and an elevated battery stack, according to one or more embodiments; and

FIG. 7 illustrates a gravity feed and gravity return system with standpipes and multiple battery stacks, according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

One or more embodiments relates to a method of using gravity feed to control the distribution of electrolytes through a battery stack portion of a redox flow battery. In one or more embodiments, gravity feed can be used to distribute electrolytes through the battery stack without the need to place pumps between the electrolyte storage tanks and the battery stack. In one or more embodiments, several methods of using standpipes to provide sufficient head pressure to push electrolyte through the battery stacks may be shown, which may eliminate the need to elevate the electrolyte storage tanks themselves. Through the use of such standpipes, as only an example, a near laminar flow of electrolyte may be introduced to the battery stack thus reducing stress on the battery membranes. In addition, as gravity feed can be accomplished without elevating storage tanks containing electrolyte acid solutions, cost and safety concerns can be alleviated over conventional gravity feed systems that require elevation of the electrolyte acid solutions. Still further, in one or more embodiments, with such standpipes, a gravity return process may be available for returning electrolyte from the battery stack to the storage tank without the need to place pumps between the battery stack and the electrolyte storage tanks. One or more embodiments also offer the ability to “black start” the battery without need for external power.

In one or more embodiments, pressure differences across a flow battery membrane may be reduced, turbulence induced membrane fluttering may be reduced, and feedback induced membrane oscillations in flow batteries may be reduced, which may prolong battery life and operation.

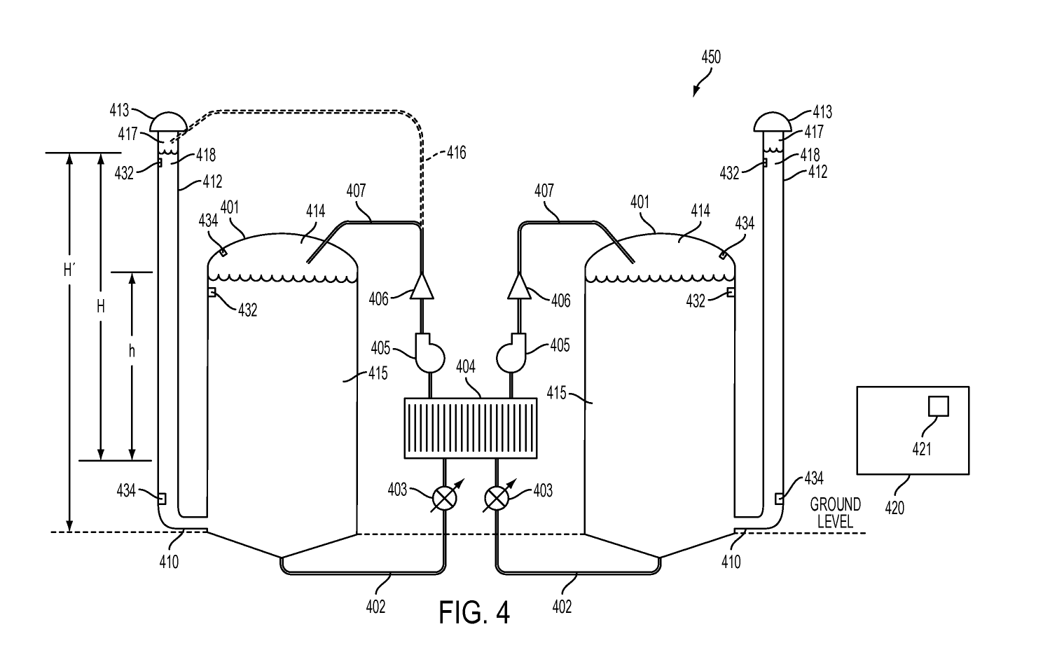

FIG. 4 illustrates a gravity feed flow battery system 450 with standpipes and pressurized storage tanks, according to one or more embodiments. As shown in FIG. 4, storage tanks 401 may be arranged so as to be resting on the ground along with standpipes 412 to provide additional head pressure at the base or inlet of the battery stack 404, according to one or more embodiments. Here, it is noted that the though an example embodiments shows the storage tank 401 and standpipe 412 resting on the ground, alternate arrangements are also available. The electrolyte 415 in storage tank 401 may flow out the bottom pipe 402, through a variable opening valve 403, and into the bottom or inlet of the battery stack 404. Return pumps 405, which may be located above the battery stack 404, transfer the electrolytes from the top or outlet of the battery stack 404 into the top of the storage tanks 401. In such an arrangement, a desired height H to produce a sufficient gravity feed through the battery stack may be obtained by using standpipes 412. Here the standpipes 412 may be connected directly to the near-bottoms of the electrolyte storage tanks 401 at inlet 410 and extend for some height above the storage tanks. Since the electrolyte 415 and the trapped gas 414 are in a sealed system, the entire system may become pressurized equal to the hydrostatic pressure created by the height of the electrolyte in the standpipe 412, or at least an equalization of pressure in the storage tank 401 and the standpipe 412. A snorkel 413 may be attached at the tops of each standpipe so that the pressures at the top of each standpipe are maintained at atmospheric pressure without introducing outside gases or containments into the system. Here, though such a snorkel embodiment is disclosed, embodiments are not limited thereto. Trapped gas 414 in the storage tank 401 may be maintained above atmospheric pressure because of the standpipe 412, such that the storage tank 401 may not need to have a snorkel.

In FIG. 4 electrolyte emerging from the top or outlet of the battery stack 404, passes through return pump 405, and through one-way valve 406, and then through pipe 407 to the top of the storage tank 401. An alternate path 416 is possible where the electrolyte is transported directly to the top of the standpipe 412, e.g., from return pump 406. In another embodiment, it may be be desired to place the connection 410 between the standpipe 412, e.g., from another or alternate outlet of the standpipe 412, and the storage tank 401, e.g., another or alternate inlet of the storage tank 401, near the top of the storage tank 401 instead of near the bottom of storage tank 401 in order to effect better mixing of processed and unprocessed electrolyte within the storage tank 401.

In FIG. 4 the electrolyte storage tanks 401 may be situated at ground level. The bottoms of the storage tanks 401 are shown to have a funnel like shape that protrudes somewhat into the ground, and some of the plumbing is also shown below ground level, noting that alternatives are available. The bottoms of the storage tanks 401 may be flat, curved, or have more complex shapes determined by other requirements. This is an advantageous arrangement of the tanks and plumbing, but it is understood that various environmental, safety, or economic considerations may preclude this arrangement, or weigh in favor of alternate arrangements, at a particular installation.

In the battery stack 404, the two electrolytes may be separated from one another by an ion exchange membrane. Depending on embodiment, positive and negative electrodes of a battery cell may be inert and serve to collect or distribute the electric charge to, from, or between the battery cell(s). The membrane may divide the battery into two half-cells, for example, with each half-cell having at least one electrode, e.g., a respective positive or negative electrode depending on the half-cell. Here, each half-cell may be made up of a rectangular frame with a central rectangular cavity, with the membrane being stretched across one side of the frame and a conductive graphite plate, as only an example, serving as the electrode and extending across the other side of the frame, noting that alternative arrangements are equally available. Depending on embodiment, a rectangle of electrically conductive carbon felt may be of a form so as to fit inside and fill the entire cavity of each half-cell to assist in collecting or distributing electric charge from the electrolyte.

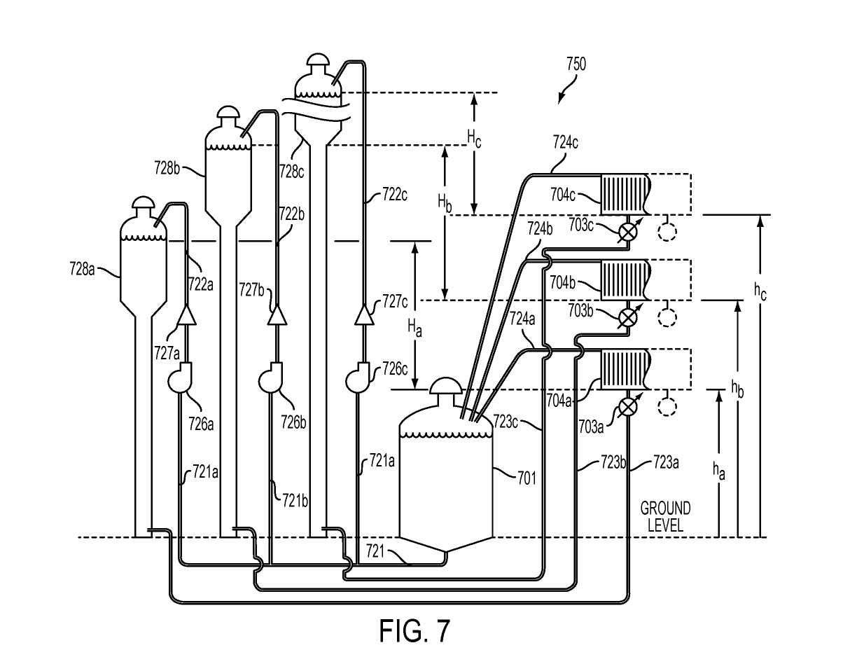

As shown in FIG. 4, positive electrolyte could be controlled to flow through a positive half-cell and negative electrolyte could be controlled to flow through a negative half-cell, and charges could be drawn from or introduced to the respective electrolytes of the positive and negative half-cells. The battery stack 404 may be made up of a single half-cell that positive electrolyte is transported through along with a single half-cell that negative electrolyte is present in or transported through, or the battery stack 404 may be made up many such positive and negative half-cells. As discussed in more detail below, there may also be many such battery stacks 404, such as demonstrated in FIG. 7, as only an example, and each battery stack 404 may represent a collection of such multiple battery cells, and include internal flow elements or plumbing to transport a positive electrolyte between positive electrode half-cells and a negative electrolyte between negative electrode half-cells, or between an inlet and outlet of the battery stack 404, as only examples, noting that alternative battery cell arrangements with alternative internal plumbing are available, such that embodiments should not be limited to only the descriptions herein. Similarly, as noted, FIG. 7 demonstrates one example of how battery stacks may be provided electrolyte, where the appropriate positive or negative electrolyte inlet of each battery stack 704a, 704b, and 704c is provided electrolyte separately through respective different feed lines or plumbing. However, herein, alternative arrangements for multiple battery stacks are also available, such as an in-line flow where electrolyte flows through more than one battery stack before being returned through the return system to the storage tank and/or standpipe(s). Again, in the embodiments herein, alternative arrangements of the plumbing to respective battery stacks, or between battery stacks, are also available, and embodiments should not be limited to only the descriptions herein. There may be differing methods of transporting positive and negative electrolytes among the battery stacks and/or for transporting positive and negative electrolytes directly to respective battery stacks, or alternate groupings of battery stacks. Such alternative arrangements of internal plumbing of the battery stack(s), and alternative plumbing of the feed line(s) and for respective plural battery stacks, and selective mixing of the same, e.g., depending on installation, should be interpreted as available for each of the described embodiment herein.

In addition, FIG. 4 further illustrates a controller 420 that is connected, or at least in communication with one or more of the return pumps 405, one-way valves 406, variable opening valves 403, other electrolyte transportation elements in the flow battery system 450, electrolyte height sensors 432 in any of the standpipes 412, storage tanks 401, and/or battery stack 404, or pressure sensors 434 in any of the standpipes 412, storage tanks 401, battery stacks 404, or electrolyte transportation lines, as only examples. Here, the illustrated electrolyte height sensors 432 are not meant to represent the actual or singular placement of height sensors in each of the storage tanks 401 and the standpipes 412. Similarly, the positions or locations of pressures sensors 434 are not meant to represent the actual or singular placement of the pressure sensors 434. The controller 420 includes one or more processing devices or microcontroller 421, or the like hardware elements, that may implement any desired controlling of the elements of the flow battery system 450 for transportation of electrolyte through the battery stack 404, e.g., for charge or discharge through the battery cells of the battery stack 404.

As only an example, in one or more embodiments, the controller 420 may control a variance in the variable opening of the variable opening valves 403 and operation of return pumps 405 and one-way valve 406 to respectively transport the positive and negative electrolytes through the battery stack 404 for charging or discharging of stored charge, e.g., through positive and negative electrodes of the battery stack 404, or control a ceasing of such positive and negative electrolyte transportation for maintenance of stored charge in the storage tanks 401, as well as the standpipes 412, for example. In one or more embodiments, the controlling of the respective variable opening valves 403 may be to produce a desired flow rate through the battery stack 404, or desired head pressure at the bottom or inlet of the battery stack 404, based upon respective expected hydrostatic pressures that may be defined by the height of the liquid electrolyte in the respective standpipes 412, outlet height or position of the respective standpipes 412, and height of the bottom or inlet of the battery stack 404, for example. Thus, the head pressure at the bottom or inlet of the battery stack 404 may be based on the known physical properties and arrangement of the elements of the flow battery system 450. The respective head pressures at the bottom or inlet of the battery stack 404 may also depend on a control of the respective return pumps 406 by controller 420. As noted above, the return pump 406 may generate, an may be selectively controlled to generate, a sufficient suction force that may affect the head pressure at the bottom or inlet of the battery stack 404.

Herein, the battery stacks may have different configurations, wherein the inlet of the battery stacks may be on a lateral, top, or bottom side, just as the outlet may also be on a lateral, top, or bottom side. The inlet and outlet of the battery stacks may be configured on a same side, adjacent sides, or opposite side, as only examples, noting that battery stacks can have many different physical arrangements with multiple sides. Differing configured battery stacks may also be included in the same flow battery system. Similarly, depending on embodiment and respective elements and configurations, each of the flow battery embodiments described herein include such a controller configured to control elements of the respective flow battery systems charge, discharge, and maintenance of charge, as only an example. In embodiments herein, though the transportation system and control of positive electrolyte through a first half cell and negative electrolyte through a second half cell, e.g., through separate inlets of a battery stack, has been demonstrated as being the same for both positive and negative electrolytes, embodiments are not limited thereto. One or more embodiments may have different feed and/or return approaches for the positive electrolytes compared to the negative electrolyte, which may result in the controller having to differently control the transportation of the positive and negative electrolytes through the respective feed and/or return systems. Similarly, in embodiments with multiple standpipes where there may be different feed and/or return approaches used for different standpipes. Still further, in differing embodiments, it may be desired to have different flow rates of positive electrolyte through a positive side half-cell compared to negative electrolytes through the corresponding negative side half-cell, and this may be implemented through having different height standpipes for the positive gravity feed system compared to the negative gravity feed system, or by controlling a height of positive electrolyte in the standpipe of the positive gravity feed system to be different than the height of negative electrolyte in the standpipe of the negative gravity feed system. Accordingly, depending on desired implementation, aspects of different embodiments described herein may be selectively combined and respectively controlled by such a controller.

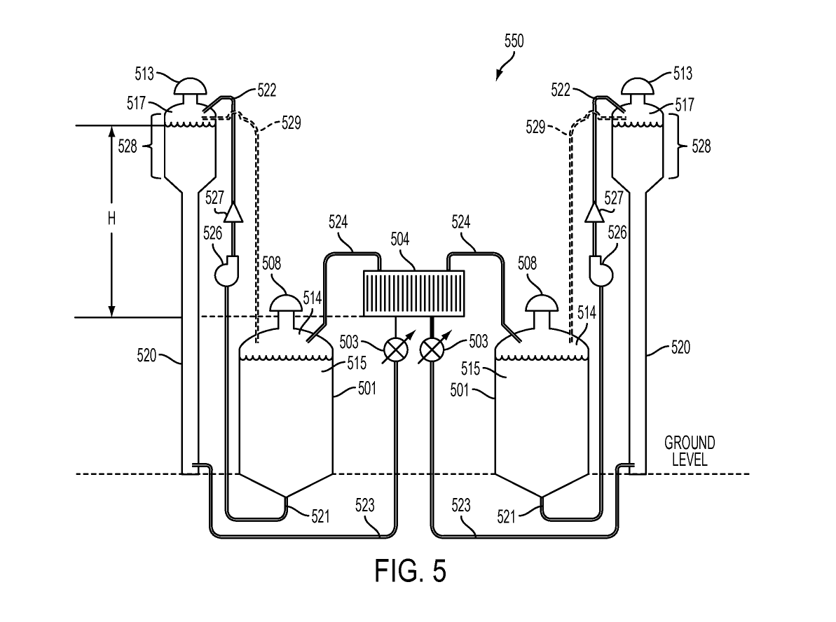

FIG. 5 illustrates a gravity feed and gravity return flow battery system 550 with standpipes and an elevated battery stack, according to one or more embodiments. In this configuration the bulk of the electrolyte may be stored in the storage tanks 501, which may be unpressurized and resting on the ground level, for example. The electrolyte flows into the tops of standpipe 520s from the storage tanks 501 through pipe lines 521 by the control of standpipe pumps 526 and one-way valves 527. When variable valves 503 are controlled to be opened electrolyte flows from the bottom of the standpipes 520, through feed pipes 523, and into the bottom or inlet of the elevated battery stack 504. In this arrangement, the battery stack 504 is elevated above the storage tanks 501 to allow electrolyte flowing out of the top or outlet of the elevated battery stack 504 to flow down, e.g., without pump assistance, through “gravity return”, into the top of the storage tanks 501. Overflow, if any, from the top of the standpipe flows down through pipe 525 and into the top of the storage tanks 501. Gas 517 trapped at the top of the standpipe 520 may be maintained at atmospheric pressure by snorkel 513. Similarly, gas 514 trapped at the tops of the storage tanks may be maintained at atmospheric equilibrium with trapped gas through snorkels 508. Likewise the top or outlet of the elevated battery stack 504 may be maintained at atmospheric equilibrium with trapped gases at 514 and 517 because of the return pipe 524. Thus, the bottom or inlet of the elevated battery stack 504 may be presented a head pressure determined by the height H. For example, the hydrostatic pressure at the outlet of the standpipe 520 may be dependent on the illustrated height H′, so that the resultant head pressure at the bottom or inlet of the battery stack 504 is based on that hydrostatic pressure and any pressure losses and/or gains in the feed pipes 523. As in the previous embodiments, the flow rate may be controlled by variable valve 503, with flow rate settings being controlled and determined by the controller of the flow battery system 550, such as illustrated in FIG. 4.

FIG. 5 illustrates the use of standpipes to bring about a gravity feed system in which all storage tanks and the battery stack are near or at ground level, and in which none of the storage tanks have elevated pressures. Here, the term ‘ground level’ may refer to the level of the surrounding environment's ground, or merely a reference level. The electrolyte may flow from the bottom of standpipe 532, through feed pipe 523, through variable valves 503, and into the bottom of the battery sack 504 with a head pressure ultimately based on by the height H. The electrolyte may emerge from the top of the battery stack 504 at substantially atmospheric pressure because the battery stacks are connected to the main tanks through return pipes 524, which may be maintained at atmospheric pressure by snorkels 508, for example. As noted above, the return pipes 524 would then transport the emerging electrolyte to the storage tanks 501. A set of standpipe pumps may then periodically transfer electrolyte from storage tanks 501 to the tops of the standpipes 520 to complete the cycle. As noted above, electrolyte levels in the standpipe 520 and storage tank 501 may be monitored by the controller of the flow battery system 550, as well as potential pressure sensors, so such respective periodic transfer of electrolyte from either of the storage tanks 501 to the tops of the standpipes 520 may be controlled, e.g., to control the height of the electrolyte in the standpipes 520 to control the head pressure at the bottom or inlet of the battery stack 504 and/or flow rate within one or more battery stacks 504. For an example, the controller may use the electrolyte height information to turn standpipe pump 526 on when the electrolyte height is low in the standpipe, and turn the pump off when the electrolyte reaches near the top or height H of the standpipe, for example. In the event such a feedback system fails, overflow pipe 529 may optionally be installed to direct excess electrolyte from the standpipe 520 back into the storage tank 501. In one or more embodiments, overflow pipe 529 could initially provide the overflow electrolyte from the standpipe 520 to a separate overflow tank, and then electrolyte in the separate overflow tank could be provided back to the storage tank 501.

In one or more embodiments, at least the tops of the standpipes may generally be exposed outdoors above the battery facility, while generally the storage tanks may be protected from temperature extremes by being housed inside a facility, storage tank mounted snorkels may optimally be indoors and less exposed to the outdoor hazards and extremes. Overflow pipe 525 may provide gas pressure equalization between the gas 517 at the tops of the standpipes 520 and the gas 514 at the top of storage tanks 501. In one or more embodiments, as shown in FIG. 5, the standpipe termination at its top may include a flared bulbous cavity 528 instead of an abrupt termination, such as shown in FIG. 4. This cavity may provide a buffer to changes in fluid height caused by on-off actions of the standpipe pump 526 and may greatly reduce the frequency of such on-off pump actions.

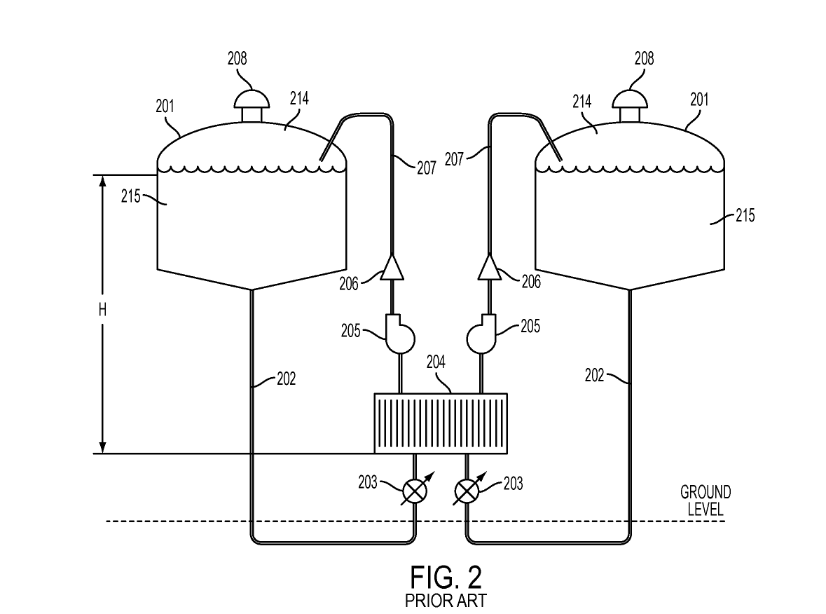

The arrangement of components illustrated in FIG. 5 may avoid the need of high-pressure storage tanks and may allows all the storage tanks to reside at ground level, or near ground level. As shown, in one or more embodiments, the battery stack may be elevated above the main tanks. In one or more embodiments, such an arrangement of FIG. 5 is used to produce a smooth continuous nearly-laminar flow of electrolyte through the battery stack that minimizes stress on the membranes and seals. Such advantages may be obtained at a comparatively low cost of an added standpipe and associated standpipe pumping system, e.g., for each storage tank. As only an example, in an embodiment where the flow battery is a vanadium redox flow battery and the electrolyte is vanadium sulfuric acid, there may be approximately 6,600 gallons of positive electrolyte and 6,600 gallons of negative electrolyte that may be used for every megawatt (MW) of battery capacity, noting that embodiments herein are not limited to such examples of electrolyte and/or quantity for such a MW capacity. Regardless, with this example, the electrolyte may be controlled, e.g., by the controller, to pass through battery stacks three times to become fully charged or discharged. Therefore, some 330 gallons of positive electrolyte and 330 gallons of negative electrolyte may pass through battery stacks each minute during peak operation. Further, in one or more embodiments, it may be desirable to have a reserve of 330 gallons of electrolyte in such a described top bulbous cavity portion of each standpipe. This would provide a one-minute supply of electrolyte in the standpipes. In this example design the large electrolyte storage tanks would contain 6,600 gallons and each standpipe would contain a height of electrolyte where the standpipe has a narrower form and potentially 330 gallons of electrolyte in the bulbous cavity portion, without having to elevate the storage tank. Rather, in the conventional approach discussed with regard to FIG. 2, to achieve a comparable MW of battery capacity it would have been necessary to elevate the electrolyte, resulting in at least at total of 13,000 gallons of such a vanadium sulfuric acid electrolyte being elevated above the battery stacks for each MW of battery capacity. Again, such a conventional approach is both dangerous and potentially more expensive to maintain, compared to an example embodiment where the storage tanks do not have to be elevated for sufficient head pressure to be generated at a bottom or inlet of a battery stack for electrolyte to be forced through the battery half-cells of the battery stack.

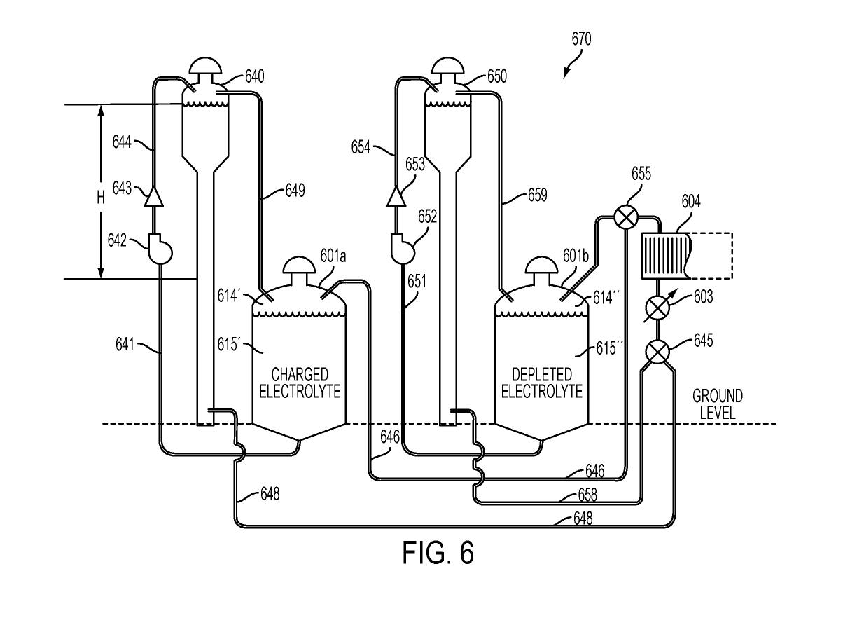

FIG. 6 illustrates one half-cell side of “four”-tank redox flow battery system 670 with standpipes and an elevated battery, according to one or more embodiments. As noted, FIG. 6 illustrates one side of redox flow battery system, i.e., a electrolyte transporting side for one half-cell of such a redox flow battery. In one or more embodiments, the electrolyte transporting side for the remaining half-cell, i.e., with both half-cells making up a battery cell in the battery stack 604, may be identical as the electrolyte transporting side shown in FIG. 6, though alternative arrangements are also available. As shown in FIG. 6, fully charged electrolyte stored in storage tank 601a may be controlled to exit the bottom of the tank through pipe 641 and be transported to the top of standpipe 640 using standpipe pump 642 and associated one-way-valve 643, for example. By including a bulbous top portion, electrolyte in a state of turbulence due to such a pumping action may reside mostly in the bulbous top portion of the standpipe 640. Electrolyte may then flow out of the bottom of the standpipe 640 through feed pipe 648, having lost some or most of the turbulence it had at the top of the standpipe 640. The charged electrolyte may then flow through feed pipe 648 to two-way valve 645. If the flow battery is in discharge mode, valve 645 may be set by the controller to allow charged electrolyte to pass through to variable valve 603, which may then set the flow rate somewhere between zero and its maximum value, for example. After flowing through the battery stack 604 and releasing its stored electrical energy, the now depleted electrolyte may immediately encounter two-way valve 655, which may be set by the controller to allow the depleted electrolyte to flow by gravity into storage tank 601b which contains depleted electrolyte. In a like manor, during a charging mode, depleted electrolyte from storage tank 601b may controlled to be pumped by standpipe 652, through valve 653, into the top of standpipe 650. Depleted electrolyte may then exit the bottom of standpipe 650 by gravity flow, through feed pipe 658, to valve 645. During the charging cycle valve 645 may be controlled to be positioned to allow depleted electrolyte from feed pipe 658 to flow into the battery stack 604 where battery action recharges the electrolyte. The now charged electrolyte may then be directed by valve 655 to flow by gravity through return pipe 646 directly, for example, into storage tank 601a to complete the cycle. As in previous embodiments, the flow rate may be controlled by variable valve 603, with flow rate settings being controlled and determined by the controller of the flow battery system 670, such as illustrated in FIG. 4.

An advantage of the “four”-tank gravity feed system, over “two”-tank gravity feed systems such as FIGS. 4-5 and 7, is that it allows fully charged electrolyte to flow through the battery during discharge and fully discharged electrolyte to feed the battery during the charge cycle, which may achieve great or maximum efficiency at all times. The disadvantage may be that twice as many standpipe pumps, tanks, and plumbing may be required for the four tank flow battery system, thus potentially doubling the hardware cost. In addition, in a four-tank system, at any given moment, half of the storage tanks may be empty. Still further, for given electrolyte capacity, a four-tank system may occupy roughly twice the physical volume as a two-tank system, making it less practical for some applications.

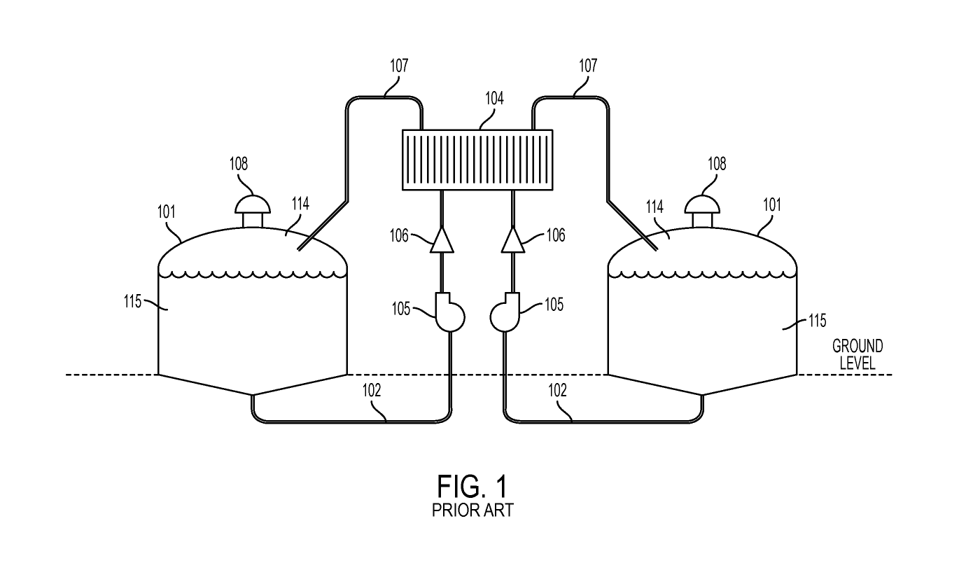

In one or more drawings the battery stack is schematically shown as a simple box with parallel lines symbolizing the battery cells. In practice, as noted above, a commercial flow battery may contain a large number of battery stacks, with each stack occupying as much as a cubic meter in volume, as only an example. The battery stacks may be mounted on racks positioned at ground level or elevated. The battery stacks may usually be electrically wired together in series within each stack, and in parallel between each stack. In one or more embodiments, pathways, called manifolds, may be provided to distribute the flow of positive and negative electrolyte within each battery stack. Tubes, pipes, valves, and other plumbing elements external to the individual battery stacks may be used to collect and distribute electrolyte between the battery stacks and the storage tanks as appropriate. In one or more embodiments, in large installations each rack may have several shelves of battery stacks arranged at different heights, e.g., above the floor. If the electrolyte is being distributed by gravity feed then the height of the battery stack relative to the height of electrolyte in the standpipe may determine the head pressure at the input to each battery stack. In one or more embodiments, it may be advantageous to have the same input head pressure for all the battery stacks at an installation, so a different height of standpipe may be used, with the respectively controlled different heights H, for each shelf level of battery stacks. Alternatively, the heights of the electrolyte in respective standpipes having the same or variable heights may be controlled to be different by the controller, so long as a desired head pressure is provided at the bottom or inlet of each respective battery stack. Again, here, as noted above, in one or more embodiments, such a desired head pressure can be controlled to be provided to the respective battery stacks without using a feed pump, such as shown in FIG. 1, and in one or more embodiments, without either of a feed pump or return pump. Without such feed and/or return pumps a more laminar flow of electrolyte can be provided through each respective battery stack, compared to systems where either are necessary.

FIG. 7 illustrates a gravity feed and gravity return flow battery system 750 with standpipes and multiple battery stacks, according to one or more embodiments. Similar to FIG. 6, only one electrolyte transportation side of the system is shown to reduce the complexity. In this arrangement, the rows of battery stacks may be mounted in a rack containing three example shelves at different heights: hₐ, h_{b}, and h_{c}, as only an example. Electrolyte in the storage tank 701 may be controlled to flow through standpipe feed pipe line 721 and its respective components standpipe feed pipes 721a, 721b, and 721c to standpipe pumps 726a, 726b, and 726c through one-way-valves 727a, 727b, and 727c to the tops of standpipes 728a, 728b, and 728c. The electrolyte may then be respectively controlled to flow by gravity from the bottoms, or outlets, of standpipes 728a, 728b, and 728c through feed lines 723a, 723b, and 723c to the variable valves 703a, 703b, and 703c and into the respective bottoms, or inlets, of the battery stacks 704a, 704b, and 704c. Upon the completion of the battery reactions, the electrolyte may be respectively controlled to flow by gravity from the tops of battery stacks 704a, 704b, and 704c through return lines 724a, 724b, and 724c back to the top of the main electrolyte storage tank 701. In such an embodiment, the shortest standpipe 728a may feed its electrolyte to the lowest height battery stack 704a, the intermediate height standpipe 723b may feed its electrolyte to the middle height battery stack 704b, and the highest standpipe 728c may feed its electrolyte to the highest height battery stack 704c. In an embodiment, the heights of the standpipes may be arranged so that the differences in height Ha, Hb, and Hc between the bottoms of each respective battery stack and the top of the fluid levels in each associated standpipe is equal, noting that alternatives are available. Alternatively, if the standpipes are all the same highest height, it may be possible to merely control different electrolyte heights with respect to the battery stacks to be maintained in each standpipe. Regardless, when such a condition is met, e.g., when the differences in height are controlled to be equal, each of the battery stacks may have the same gravity induced head pressure. This type of arrangement could be used to provide equal gravity-induced head pressure to rack-mounted battery stacks having any number of shelves, depending on embodiment. In addition, this arrangement of FIG. 7 can be adapted for use in a four tank system, such as shown in FIG. 6. As in previous embodiments, respective flow rates may be controlled by variable valves 703a, 703b, and 703c, with flow rate settings being controlled and determined by the controller of the flow battery system 750, such as illustrated in FIG. 4.

As noted in previously, in conventional gravity feed flow battery systems it was necessary to elevate the storage tanks above the battery stack, which became difficult and dangerous because of the large volumes of electrolyte acid solution. Thus, if a large gravity feed flow battery were previously desired, e.g., a flow battery with a capacity for storing 1 megawatt of electric energy, it would have been necessary to elevate over 10 thousand gallons of an acid electrolyte solution, above the battery stack, such as shown in FIG. 2. However, as demonstrated in one or more embodiments herein, when a standpipe is included in such a system it is no longer necessary to elevate the storage tanks, as only the electrolyte in the standpipe may need to be controlled to reach to heights above the battery stack bottom or inlet. In addition, as demonstrated in one or more embodiments, the standpipes also do not have to be elevated. However, in embodiments where the standpipes are elevated, there may still be substantially less volume of electrolyte in the standpipes than in the storage tanks, similarly resulting in reduced risks. Accordingly, as an embodiment, using the above example implementation for a flow battery with a 1 Megawatt capacity, if the electrolyte acid solution is a vanadium electrolyte, with an example of 1.54 molar vanadium in a 2.0 molar sulfuric acid solution in water, or potentially an acid mix that uses 3-4 molar sulfuric acid, then 13,200 gallons of the vanadium electrolyte may be needed to store 1 megawatt of electric energy. In such an embodiment, three cycles or passes of the electrolyte through the battery stack may be desired to fully charge or discharge the flow battery, and some 19,800 gallons of electrolyte would thus travel through the battery stack(s) on both positive and negative sides. Here, for this example charging or discharging, the flow rate could then be 19,800 gallons per hour, or 330 gallons per minute, on each side of the battery stack(s), for example. In such an example, there may be an example 120 individual battery stacks, so that when charging or discharging, the flowing electrolyte is routed by internal and/or external plumbing to flow at a same rate for each battery stack, so the flow rate would be 2.75 gallons per minute per battery stack. As only an example, the configuration of FIG. 7 may result in equal flow rates for each battery stack. Still further, with such an example vanadium electrolyte flow battery, because of the large density of the vanadium sulfuric acid mix, it is not necessary for the standpipes to be too tall or support electrolyte at very large heights to induce sufficient flow of electrolyte from the standpipe (such as in FIGS. 5-7) or the storage tank (FIG. 4) to the bottom or inlet of the battery stack to force the electrolyte through the battery stack. For example, in one or more embodiments, a electrolyte standpipe height between 15 and 20 feet above the height of the bottom or inlet of a particular battery stack may create sufficient hydrostatic pressure to force the electrolyte through that particular battery stack. In addition, depending on embodiment, this sufficiency of hydrostatic pressure may result in substantially more head pressure at the bottom or inlet of the battery stack(s), and result in substantially greater flow rates, than is minimally required to force or cause inlet electrolyte to transport through and exit the battery stack(s).

The particular height difference, such as height difference H in FIG. 5, which would be accordingly based upon a corresponding hydrostatic pressure created by the physical attributes of the standpipe and height H′ (FIG. 5) of the electrolyte in standpipe beginning at the height of the outlet of the standpipe, may be determined through experimentation to determine the appropriate H for desired flow rate(s) through each respective battery stack. Knowledge of the predetermined H may then be used by the controller of the flow battery system to attempt to maintain such a height difference, such as through increasing of electrolyte to the standpipe using standpipe pumps 526 and/or selective removal of overflow electrolyte from the standpipe through overflow line 529 of FIG. 5. The controller may institute such control also based upon the controlled variable setting of the variable valve 503 of FIG. 5. Though the appropriate height H may be calculated, it may be more effective to determine the height H through the indicated experimentation, such as during an initial set up of the flow battery system. For example, the particular resistance to the flow caused by the viscosity of the electrolyte and its passage through the carbon felt (for example) within each battery half-cell of the battery stack may be more easily determined through experimentation.

In one or more embodiments, the large flow batteries may be useful as an emergency back-up power source in the event that the electric grid power fails because of a storm or other cause, for example. This circumstance is referred to as “black start” battery operation. Under such circumstances the backup battery is desirably able to immediately begin supplying supplementary electric power upon detection of the grid failure. But flow batteries are complex mechanisms that depend on pumps, sensors, controllers, and other electronic devices for their operation so a grid failure would prevent a conventional flow battery from operating, as the electrolyte transportation may not be feasible without power from the grid. Under these circumstances it would seem that a flow battery could draw on its own stored power, if available, to black start itself. But if the flow battery has been standing unused for a time previous to the grid failure, the electrolyte contained within the battery stack would very likely be self-discharged over time. In addition, even if power becomes available from the stored reserves of the flow battery system, the start up of the flow battery system may not be immediate.

A gravity feed flow battery has a systemic advantage in black start operations. Simply opening the variable valve at the bottom or inlet of the battery stack may immediately introduce fresh electrolyte to the battery stack enabling the initiation of a self-start sequence. For example, in one or more embodiments, an included small battery pack could provide the power needed to turn on the variable valve and maintain grid failure sensors. Such a small battery pack could also power the controller. Alternatively, the variable valve could have the added feature of automatically reverting to an open state in the event of a grid power failure, and the controller could then be powered by the flow battery. Alternatively, a smaller jump-start valve could be added to the bottom or inlet of the battery stack that only opens in the event of a grid power failure to initiate a small flow of electrolyte. Alternatively, the valve may be manually operated. Depending on embodiment, other arrangements are also possible that require very little power to provide black start operational capability.

Embodiments of the present invention should not be considered limited to the specific examples described herein, but rather should be understood to cover all aspects of the invention. Various modifications, equivalent processes, as well as numerous structures and device substitutions may be applicable and will readily be apparent to those of skill in the art. Those skilled in the art will understand that various additions, changes, and re-configurations may be made without departing from the scope of the invention, which is not to be considered limited to what is described in the specification.

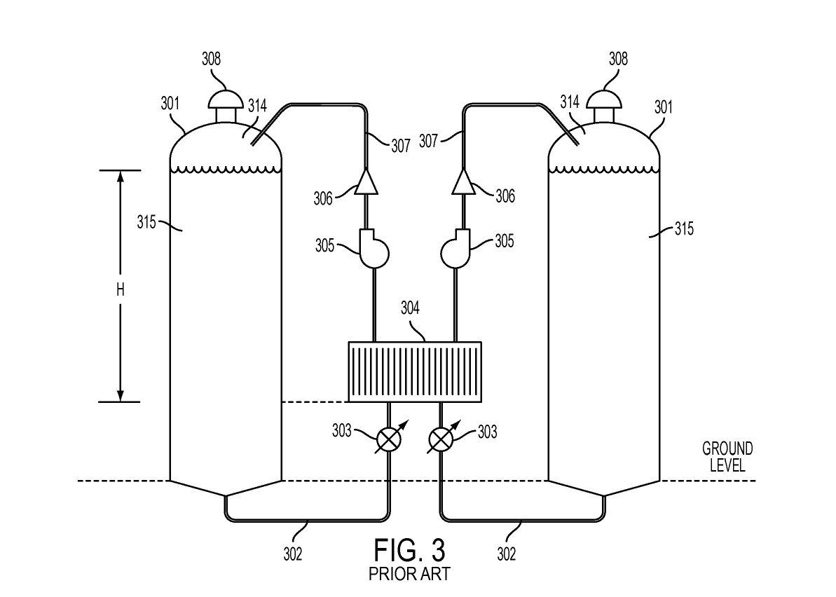

As discussed above, FIGS. 3-5 and 7 illustrate “two”-tank flow battery embodiments. Depending on embodiment, where both charged and depleted electrolyte may be mixed together. Alternatively, each of these arrangements of FIGS. 3-5 and 7 could be implemented as a “four”-tank system, such as shown in FIG. 6. In a very large two-tank battery system there may be more than one storage tank containing positive electrolyte and more than one storage tank containing negative electrolyte, with associated valves and plumbing. Likewise in a four-tank flow battery system there may be multiple tanks of each type, negative and positive, and depleted and charged, with associated extensions of the plumbing and valves to accommodate switching from tank to tank during battery operation.

Depending on embodiment, the electrolyte storage tanks may be of any size, and they may be fabricated of plastics, metals, or other materials, they may be of any convenient shape and volume, and they could be fabricated of flexible materials such as rubber coated fabrics, as only examples. The tanks may be pressurized or unpressurized as required. The storage tanks may include heating or cooling elements or devices as required, or desired, and may be housed outdoors or indoors. The tanks may include snorkel mechanisms having various degrees of complexity including to possibility of having indoor tanks with snorkels extending outdoors, for example. The electrolyte storage tanks may be mounted on the ground or floor, or above ground on a supporting structure, or below ground. The tanks may generally be contained within a containment structure or tray to prevent electrolyte leaks or spills from entering the environment. The bottoms of the tanks may funnel the fluids to the output plumbing, or be flat, or have and other shape determined by function or design, depending on embodiment. In addition, the tanks may have multiple input and output electrolyte flow terminals, access ports, viewing ports, sensor attachment means, and other accessories.

Plumbing connecting the electrolyte storage tanks to the battery stack(s) is shown in the drawings in a simple form to enhance clarity of understanding of the flow paths, noting that the plumbing may likely be more complex in actual implementation, in one or more embodiments. In addition to a minimum number of pumps and valves shown in the drawings, embodiments include systems with additional pumps, additional safety and control valves, one-way valves, heat exchangers, sensor and sample access means, viewing ports, redundant and alternative flow paths, disconnect unions, filtering means, venting means, and other components. Herein, depending on embodiment, one or more of the pumps may also be variable speed pumps, e.g., with the controller controlling the speed of such pumps, such as controlling the speed of standpipe pumps to control the inlet pace of electrolyte to a corresponding standpipe from a storage tank. The pipes and other plumbing components may be made of plastic, glass, metal, or other suitable materials, as only examples.

In a commercial implementation of a redox flow battery, according to one or more embodiments, some or most of the valves and pumps are controlled by a device or devices referred to as a “controller”, which may be a microcontroller, specialized computer, or computer controlled by computer readable code or instructions included on a non-transitory medium to implement control method embodiments described herein. The controller(s) may be used to time and activate, as necessary, the various pumps and valves, for example. However, one or more embodiments also includes manual operation, remote operation, mechanical activation, or any other technique for controlling the pumps, valves, and other actions that may be performed to carry out embodiments.

Depending on embodiment, the flow battery stacks may be generally mounted on metal racks, which may contain several shelves at different heights. Here, the racks may generally be fabricated out of steel, but could be made of wood, plastic, or other suitable materials, depending on embodiment. The mounting racks may include elements to bolt the mounting racks to the floor; mounting elements for the tubes, pipes, wires, and the like; and mounting elements for sensors, controllers, valves, switches, and the like. Depending on embodiment, individual racks may be attached together to form a three dimensional matrix of shelving for the support of many battery stacks, as only an example. Still further, in one or more embodiments, the storage racks may be mounted in a catch basin or tray to contain electrolyte spills.

As shown in FIGS. 4-7, the standpipes may be simple pipes erected in a vertical configuration having a snorkel on the top and sealed at the bottom with input and output lines, noting this is only an example. The bulbous protrusion shown at the top portion of the standpipes in FIG. 5-7 provide for a more uniform maintenance of fluid pressure during periods when fluids are being pumped into the standpipe or fluids are being withdrawn during battery usage, though such a protrusion or orientation is not necessary. In one or more embodiments, each of the standpipes may be a stand-alone standpipe. Alternatively, depending on embodiment, two or more standpipes may very likely be combined into a single structure, e.g., having multiple bulbous chambers and multiple input and output lines. In an embodiment, the positive and negative standpipes of FIG. 5, as only example, could be combined into a single structure with a positive and a negative electrolyte chamber near the top and separate input and output lines for the positive and negative electrolytes, again, as only an example. Likewise, in an embodiment, in FIG. 6, the represented four standpipes providing gravity pressure for the positive and negative and the charged and uncharged electrolyte could be combined into a single standpipe structure, again, as only an example. Similarly, in an embodiment, the six standpipe system represented in FIG. 7 could be combined into a single structure, e.g., having bulbous tanks positioned at different heights, and multiple input and output lines going in and out of the structure, again, as only an example. Lastly, in very large systems with multiple tanks of each type, the standpipes could be combined with even greater numbers of chambers and numbers of input and output lines.

In one or more embodiments, the standpipes shown in FIGS. 4-7, or the complex standpipe structures described directly above, could be made of metal, plastic, or other suitable materials, or a combination thereof. The standpipes may be floor mounted, roof mounted, or extend from inside the building and out through the roof. The standpipes may be of whatever height provides the desired or necessary head pressure(s) at the battery stack. Depending on embodiment, the standpipe may provide greater than a minimum pressure and use a variable valve to reduce the pressure to whatever is desired or needed for the desired gravity flow. Depending on embodiment, the single or multiple standpipe structures could also include a supporting structure or scaffolding to support the standpipes, their plumbing, and related components, for example. In one or more embodiments, the standpipe may include heating and/or cooling elements or devices to keep the electrolyte at the desired temperature, or above/below particular temperatures; it may include sensor access ports, cleanout ports, access ports, and other utility structures; it may have pump mounting elements, light mounting elements, and mounting elements for other functions; and it may include ladders, supporting posts, braces, and other mechanical elements as needed.

In one or more embodiments, the various gravity flow arrangements discussed herein could be adapted to a series or parallel flow of electrolyte through the stacks. Heat exchangers, one-way-valves, clean-out ports, safety release vents, filters, sensors, and other devices may be inserted in the electrolyte flow paths. The various elements of a gravity flow battery system shown in the drawings may be reconfigured into other arrangements and designs within the scope of this invention. In one or more embodiments, the flow battery type may be any of iron/tin, iron/titanium, iron/chrome, vanadium/vanadium, sodium/bromine, zinc/bromine, and other possible reactant couples. Embodiments described herein may apply to flow batteries of any workable size, scale, or configuration.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A flow battery system comprising:
a first battery stack including a first half-cell utilizing a liquid electrolyte;
a first gravity feed system, including at least a first storage tank and a first standpipe, designed to generate a first hydrostatic pressure in the first standpipe for the liquid electrolyte in the first standpipe sufficient to force the liquid electrolyte to be fed from the first gravity feed system through the first half-cell; and
a return system to return the liquid electrolyte from the first half-cell to the first gravity feed system.

2. The flow battery system of claim 1, wherein the sufficiency of the first hydrostatic pressure in the first standpipe, to force the liquid electrolyte to be fed through the first half-cell, is based on any inlet suction pressure of the first half-cell produced by the return system.

3. The flow battery system of claim 2, wherein the return system includes a return pump to pump the liquid electrolyte into the first storage tank after having exited the first half-cell.

4. The flow battery system of claim 1, further comprising a controller to control a height of the liquid electrolyte in the first standpipe to match a predetermined height above a height of the first battery stack to generate the sufficient first hydrostatic pressure to force the liquid electrolyte to be fed from the first gravity feed system through the first half-cell when charging or discharging battery cells of the first battery stack.

5. The flow battery system of claim 4, wherein the sufficient first hydrostatic pressure is a hydrostatic pressure that generates a head pressure at the first battery stack that is greater than a minimum head pressure needed to force the liquid electrolyte to be fed through the first battery stack.

6. The flow battery system of claim 4, further comprising a variable valve in a fluid transport path of the liquid electrolyte being fed from the first gravity feed system to the first battery stack,
wherein the controller controls a variable opening of the variable valve to control a flow rate of the liquid electrolyte through the first battery stack when charging or discharging through battery cells of the first battery stack.

7. The flow battery system of claim 1, wherein a lowest level of the battery stack is higher than a lowest level of the liquid electrolyte in the first storage tank.

8. The flow battery system of claim 1, wherein the first gravity feed system feeds the liquid electrolyte from the first standpipe or the first storage tank to the first battery stack without using a pump.

9. The flow battery system of claim 8, further comprising a controller to control a height of the liquid electrolyte in the first standpipe to match a predetermined height to generate the sufficient first hydrostatic pressure in the first standpipe to force the liquid electrolyte to be fed from the first gravity feed system through the first half-cell.

10. The flow battery system of claim 9, further comprising a variable valve in a fluid transport path of the liquid electrolyte being fed from the first gravity feed system to the first battery stack,
wherein the controller controls a variable opening of the variable valve to control a flow rate of the liquid electrolyte through the first battery stack when charging or discharging through battery cells of the first battery stack.

11. The flow battery system of claim 1, wherein the return system is a gravity return system, such that the liquid electrolyte is fed into the first storage tank after having exited the first half-cell without using a pump.

12. The flow battery system of claim 1, wherein the first gravity feed system feeds the liquid electrolyte from the first storage tank to the first battery stack without using a pump, and the first storage tank is pressure sealed and in fluid connection with the first standpipe so as to equalize fluid pressures between the first storage tank and the first standpipe and so to produce a head pressure at the first battery stack based on the first hydrostatic pressure in the first standpipe.

13. The flow battery system of claim 12, wherein the first hydrostatic pressure in the first standpipe is based on a height of the liquid electrolyte in the standpipe from an outlet of the standpipe providing the fluid connection with the first storage tank to a top of the fluid electrolyte in the standpipe.

14. The flow battery system of claim 13, wherein the return system further comprises a return pump to pump liquid electrolyte from the first battery stack to the first standpipe.

15. The flow battery system of claim 1, wherein the first gravity feed system further comprises a standpipe pump to pump liquid electrolyte from the first storage tank to the first standpipe.

16. The flow battery system of claim 15, further comprising a controller to control a height of the liquid electrolyte in the first standpipe, to match a predetermined height above the first battery stack to generate the sufficient first hydrostatic pressure to force the liquid electrolyte to be fed from the first gravity feed system through the first half-cell, by controlling the standpipe pump to selectively pump the liquid electrolyte from the first storage tank to the first standpipe when the controller determines that the height of the liquid in the liquid electrolyte in the first standpipe is below the predetermined height.

17. The flow battery of claim 1, wherein a top of the first standpipe is fitted with a snorkel that serves to equalize pressures inside a top-most portion of the first standpipe with an atmospheric pressure existing outside the standpipe.

18. The flow battery of claim 1, wherein a top portion of the first standpipe has an expanded bulbous cavity compared to a mid height portion of the first standpipe to buffer changes in fluid height and turbulence created when the fluid electrolyte is fed into the first standpipe.

19. The flow battery of claim 1, wherein the first gravity feed system further comprises an overflow pipe installed near a top of the first standpipe to direct excess electrolyte from inside the first standpipe into the first storage tank.

20. The flow battery system of claim 1, further comprising a second battery stack, including a second half-cell, at a height different from a height of the first battery stack, and
wherein the first gravity feed system further includes a second standpipe, designed to generate a second hydrostatic pressure in the second standpipe for the liquid electrolyte in the second standpipe sufficient to force the liquid electrolyte to be fed from the first gravity feed system through the second half-cell.

21. The flow battery system of claim 20, wherein the first gravity feed system feeds the liquid electrolyte from the first standpipe to the first battery stack without using a pump, and feeds the liquid electrolyte from the second standpipe to the second battery stack without using a pump.

22. The flow battery system of claim 21, further comprising a controller to control a height of the liquid electrolyte in the first standpipe to match a first predetermined height above a height of the first battery stack to generate the sufficient first hydrostatic pressure to force the liquid electrolyte to be fed from the first gravity feed system through the first half-cell when charging or discharging battery cells of the first battery stack, and to control a height of the liquid electrolyte in the second standpipe to match a second predetermined height above a height of the second battery stack to generate the sufficient second hydrostatic pressure to force the liquid electrolyte to be fed from the first gravity feed system through the second half-cell when charging or discharging battery cells of the second battery stack.

23. The flow battery system of claim 22, further comprising:
a first variable valve in a fluid transport path of the liquid electrolyte being fed from the first gravity feed system to the first battery stack;
a second variable valve in a fluid transport path of the liquid electrolyte being fed from the first gravity feed system to the second battery stack; and
wherein the controller controls a respective variable opening of the first and second variable valves to control respective flow rates of the liquid electrolyte through the first battery stack and the second battery stack when respectively charging or discharging.

24. The flow battery system of claim 20, wherein the return system is a gravity return system, such that the liquid electrolyte is fed into the first storage tank after having exited the first half-cell without using a pump and such that the liquid electrolyte is fed into the first storage tank after having exited the second half-cell without using a pump.

25. The flow battery system of claim 20, wherein the first gravity feed system further comprises a first standpipe pump to pump liquid electrolyte from the first storage tank to the first standpipe and a second standpipe pump to pump liquid electrolyte from the first storage tank to the second standpipe.

26. The flow battery system of claim 25, further comprising a controller to control a height of the liquid electrolyte in the first standpipe, to match a first predetermined height above the first battery stack to generate the sufficient first hydrostatic pressure to force the liquid electrolyte to be fed from the first gravity feed system through the first half-cell, by controlling the first standpipe pump to selectively pump the liquid electrolyte from the first storage tank to the first standpipe when the controller determines that the height of the liquid in the liquid electrolyte in the first standpipe is below the first predetermined height, and to control a height of the liquid electrolyte in the second standpipe, to match a second predetermined height above the second battery stack to generate the sufficient second hydrostatic pressure to force the liquid electrolyte to be fed from the first gravity feed system through the second half-cell, by controlling the second standpipe pump to selectively pump the liquid electrolyte from the first storage tank to the second standpipe when the controller determines that the height of the liquid in the liquid electrolyte in the second standpipe is below the second predetermined height.

27. The flow battery system of claim 1, further comprising a second gravity feed system including at least a second storage tank and second standpipe,
such that the second gravity feed system is designed to generate a second hydrostatic pressure in the second standpipe for the liquid electrolyte in the second standpipe sufficient to force the liquid electrolyte to be fed from the second gravity feed system through the first half-cell.

28. The flow battery system of claim 27, wherein liquid electrolyte stored by the first storage tank is charged electrolyte and liquid electrolyte stored by the second storage tank is depleted electrolyte.

29. The flow battery system of claim 28, further comprising a controller to control a height of the charged liquid electrolyte in the first standpipe to match a first predetermined height above a height of the first battery stack to generate the sufficient first hydrostatic pressure to force the liquid electrolyte to be fed from the first gravity feed system through the first half-cell when discharging battery cells of the first battery stack, and to control a height of the depleted liquid electrolyte in the second standpipe to match a second predetermined height above a height of the first battery stack to generate the sufficient second hydrostatic pressure to force the depleted liquid electrolyte to be fed from the second gravity feed system through the first half-cell when charging battery cells of the first battery stack.

30. The flow battery system of claim 29, further comprising:
a charge/discharge selector valve in a fluid transport path of the charged liquid electrolyte being fed from the first gravity feed system to the first battery stack and in a fluid transport path of the depleted liquid electrolyte being fed from the second gravity feed system to the first battery stack; and
a variable valve in a transport fluid path of the charged or depleted liquid electrolyte having passed the charge/discharge selector valve to the first battery stack,
wherein the controller controls a respective variable opening of the variable valve to control a flow rate of the charged or depleted liquid electrolyte through the first battery stack when respectively charging or discharging, and controls the charge/discharge valve to transport charged liquid electrolyte from the first gravity feed system to the first battery stack when discharging the first battery stack and to transport depleted liquid electrolyte from the second gravity feed system to the first battery stack when charging the first battery stack.

31. The flow battery system of claim 28, wherein the return system is a gravity return system, such that the charged liquid electrolyte is selected to be fed into the first storage tank after having been charged and then exited the first half-cell without using a pump, and the discharged liquid electrolyte is selected to be fed into the second storage tank after having been discharged and then exited the first half-cell without using a pump.

32. The flow battery system of claim 28, wherein the first gravity feed system further comprises a first standpipe pump to pump charged liquid electrolyte from the first storage tank to the first standpipe and a second standpipe pump to pump depleted liquid electrolyte from the second storage tank to the second standpipe.

33. The flow battery system of claim 32, further comprising a controller to control a height of the charged liquid electrolyte in the first standpipe, to match a first predetermined height above the first battery stack to generate the sufficient first hydrostatic pressure to force the charged liquid electrolyte to be fed from the first gravity feed system through the first half-cell, by controlling the first standpipe pump to selectively pump the charged liquid electrolyte from the first storage tank to the first standpipe when the controller determines that the height of the charged liquid electrolyte in the first standpipe is below the first predetermined height, and to control a height of the depleted liquid electrolyte in the second standpipe, to match a second predetermined height above the first battery stack to generate the sufficient second hydrostatic pressure to force the depleted liquid electrolyte to be fed from the second gravity feed system through the first half-cell, by controlling the second standpipe pump to selectively pump the depleted liquid electrolyte from the second storage tank to the second standpipe when the controller determines that the height of the depleted liquid electrolyte in the second standpipe is below the second predetermined height.

34. The flow battery system of claim 33, wherein the first predetermined height is equal to the second predetermined height.

35. The flow battery system of claim 1, wherein the sufficiency of the first hydrostatic pressure in the first standpipe, to force the liquid electrolyte to be fed through the first half-cell, is based on a configuration of the first battery stack having an inlet fed the electrolyte from the first gravity system and/or an outlet to return the electrolyte to the return system be on lateral sides of the first battery stack.

36. The flow battery system of claim 1, wherein the sufficiency of the first hydrostatic pressure in the first standpipe, to force the liquid electrolyte to be fed through the first half-cell, is based on a configuration of the first battery stack having an inlet fed the electrolyte from the first gravity system and/or an outlet to return the electrolyte to the return system be on top or bottom sides of the first battery stack.

37. A flow battery system, comprising:
a battery stack including a battery cell, half of the battery cell being a half-cell utilizing positive terminal liquid electrolyte and another half of the battery cell being a second half-cell utilizing a negative terminal liquid electrolyte;
a first gravity feed system, including at least a first storage tank and a first standpipe for storing the positive terminal liquid electrolyte, designed to generate a first hydrostatic pressure in the first standpipe for the positive terminal liquid electrolyte in the first standpipe sufficient to force the positive terminal liquid electrolyte to be fed from the first gravity feed system through the first half-cell;
a second gravity feed system, including at least a second storage tank and a second standpipe for storing the negative terminal liquid electrolyte, designed to generate a second hydrostatic pressure in the second standpipe for the negative terminal liquid electrolyte in the second standpipe sufficient to force the negative terminal liquid electrolyte to be fed from the second gravity feed system through the second half-cell;
a first return system to return the positive terminal liquid electrolyte from the first half-cell to the first gravity feed system; and
a second return system to return the negative terminal liquid electrolyte from the second half-cell to the first gravity feed system.

38. The flow battery system of claim 37, wherein the first gravity feed system feeds the positive terminal liquid electrolyte from the first standpipe or the first storage tank to the first half cell without using a pump, and the second gravity feed system feeds the negative terminal liquid electrolyte from the second standpipe or the second storage tank to the second half cell without using a pump.

39. The flow battery system of claim 38, further comprising a controller to control a height of the positive terminal liquid electrolyte in the first standpipe to match a first predetermined height to generate the sufficient first hydrostatic pressure in the first standpipe to force the positive terminal liquid electrolyte to be fed from the first gravity feed system through the first half-cell, and to control a height of the negative terminal liquid electrolyte in the second standpipe to match a second predetermined height to generate the sufficient second hydrostatic pressure in the second standpipe to force the negative terminal liquid electrolyte to be fed from the second gravity feed system through the second half-cell.

40. The flow battery system of claim 39, wherein the first predetermined height is equal to the second predetermined height.

41. The flow battery system of claim 39, wherein the first predetermined height is different from the second predetermined height, and the controller controls a flow rate of the positive terminal electrolyte through the first half-cell to be different from a controller controlled flow rate of the negative terminal electrolyte through the second half-cell.

42. The flow battery system of claim 38, wherein the first and second return systems are gravity return systems, such that the positive terminal liquid electrolyte is fed into the first storage after having exited the first half-cell without using a pump and the negative terminal liquid electrolyte is fed into the second storage after having exited the second half-cell without using a pump.

43. A flow battery control method of a flow battery system including a first battery stack including a first half-cell utilizing a liquid electrolyte, a first gravity feed system including at least a first storage tank and a first standpipe, and a return system to return the liquid electrolyte from the first half-cell to the first gravity feed system, the method comprising:
controlling a height of the liquid electrolyte in the first standpipe to match a predetermined height above a height of the battery stack to generate a sufficient first hydrostatic pressure to force the liquid electrolyte to be fed from the first gravity feed system through the first half-cell when charging or discharging battery cells of the first battery stack; and
controlling a variable feeding of the liquid electrolyte from the first gravity feed system to the first battery stack, to control a flow rate of the liquid electrolyte through the first battery stack when charging or discharging through battery cells of the first battery stack.

44. The flow battery control method of claim 43, further comprising controlling the return system of the flow battery system to transport the liquid electrolyte, after having exited the first battery stack, to the first storage tank.

45. The flow battery control method of claim 44, wherein the return system is not a gravity feed return system and includes a return pump, arranged to pump the liquid electrolyte into the first storage tank after having exited the first battery stack, and the method further comprises controlling the return pump to transport the liquid electrolyte into the first storage tank after having exited the first battery stack.

46. The flow battery control method of claim 43, further comprising controlling the first gravity feed system to feed the liquid electrolyte from the first standpipe or the first storage tank to the first battery stack without using a pump.

47. The flow battery control method of claim 43, wherein the controlling of the variable feeding of the liquid electrolyte is performed by controlling a variable opening of a variable valve, in a fluid transport path of liquid electrolyte from the first gravity feed system to the first battery stack, and the variable feeding controls a flow rate of the liquid electrolyte in the first battery stack.

48. The flow battery control method of claim 43, wherein the controlling of the height of the liquid electrolyte in the first standpipe is performed by controlling a standpipe pump, arranged in a fluid transport path between the first storage tank and the first standpipe, to selectively transport fluid electrolyte from the first storage tank to the first standpipe to increase the height of liquid electrolyte in the first standpipe.

49. The flow battery control method of claim 43, wherein the flow battery system further includes a second battery stack, including a second half-cell, at a height different from a height of the first battery stack, and a second standpipe, and the controlling of the height of the liquid electrolyte in the first standpipe further comprises:
controlling a height of the liquid electrolyte in the first standpipe to match a first predetermined height above a height of the first battery stack to generate the sufficient first hydrostatic pressure to force the liquid electrolyte to be fed from the first gravity feed system through the first half-cell when charging or discharging battery cells of the first battery stack, and controlling a height of the liquid electrolyte in the second standpipe to match a second predetermined height above a height of the second battery stack to generate a sufficient second hydrostatic pressure to force the liquid electrolyte to be fed from the first gravity feed system through the second half-cell when charging or discharging battery cells of the second battery stack.

50. The flow battery control method of claim 43, wherein the flow battery system further includes a second gravity feed system, including a second storage tank and second standpipe, liquid electrolyte stored by the first storage tank is charged electrolyte and liquid electrolyte stored by the second storage tank is depleted electrolyte, and the method further comprises:
controlling a height of the charged liquid electrolyte in the first standpipe to match a first predetermined height above a height of the first battery stack to generate the sufficient first hydrostatic pressure to force the charged liquid electrolyte to be fed from the first gravity feed system through the first half-cell when discharging battery cells of the first battery stack, and controlling a height of the depleted liquid electrolyte in the second standpipe to match a second predetermined height above a height of the first battery stack to generate a sufficient second hydrostatic pressure to force the depleted liquid electrolyte to be fed from the second gravity feed system through the first half-cell when charging battery cells of the first battery stack.
